(19) United States
(12) Patent Application Publication
(10) Pub. No.: US 2015/0144028 A1
(43) Pub. Date: May 28, 2015

(54) AQUEOUS COMPOSITIONS AND USE THEREOF

(71) Applicant: Wacker Chemie AG, Munich (DE)

(72) Inventor: Marko Prasse, Glaubitz (DE)

(21) Appl. No.: 14/402,243

(22) PCT Filed: May 17, 2013
(86) PCT No.: PCT/EP2013/060213

§ 371 Date: Nov. 19, 2014

(30) Foreign Application Priority Data
May 24, 2012 (DE) 10 2012 208 766.4

(51) Int. Cl. C09D 5/00; C08K 5/09; C08K 5/544

(52) U.S. Cl. CPC C09D 5/002; C08K 5/544; C08K 5/09
USPC 106/287.11

(57) ABSTRACT

Aqueous compositions which contain amino functional organosilicon compounds can be used to modify inorganic, organic, or organosilicon substrates to improve their adhesion and stabilization.

### CROSS-REFERENCE TO RELATED APPLICATIONS

This application is the U.S. National Phase of PCT Appln. No. PCT/EP2013/060213 filed May 17, 2013, which claims priority to German application DE 10 2012 208 766.4 filed May 24, 2012, the disclosures of which are incorporated in their entirety by reference herein.

### BACKGROUND OF THE INVENTION

1. Field of the Invention

The invention relates to aqueous compositions which contain amino functional organosilicon compounds, processes for production thereof, and also use thereof.

2. Description of the Related Art

Compositions which contain amino functional organosilicon compounds have long been used to consolidate substrates and improve the adhesion of paints, adhesives, or sealing compounds. Usually, such compositions contain readily volatile solvent such as gasoline to ensure rapid drying, and polar solvents such as toluene for improved spreading on smooth surfaces. The solvents, however, are hazardous to health, highly flammable, and odor-intense. Therefore, solvent-free or solvent-poor compositions are of interest.

Aqueous compositions which contain amino functional organosilicon compounds are known. By using water as a base, environmentally friendly, low-odor, and non-hazardous products are obtained. However, the compositions have some disadvantages.

In EP 0577014 B1, equivalent to U.S. Pat. No. 5,363,994 A, mixtures of water with up to 0.3% amino- or mercapto-functional alkoxysilanes and with up to 0.4% hydrophobic alkoxysilanes are described, having a preferred pH of 2.0 to 5.5. In U.S. Pat. No. 5,902,645 A, mixtures are described which consist of water, alkoxysilanes, which can also be amino functional, and phosphoric acid, having a preferred pH of less than or equal to 3.0. In EP 2059561 B1, equivalent to U.S. Pat. No. 8,187,716 B2, mixtures of water, one part amino functional and mercapto functional alkoxysilanes, one part surfactants, and two parts pure acetic acid are described. In US 2001/0049021 A1, mixtures of primers with an acid which has a pKa value of about 4.75 are claimed. All of these mixtures cannot be used on acid-sensitive substrates, such as marble or concrete.

In WO 2011/112440 A1, equivalent to U.S. Pat. No. 8,673,999 B2, mixtures of water with amino functional organosilicon compounds and special surfactants are described, having a pH of 9 to 12. These described surfactants, however, lead to poor adhesion after immersion in water.

### SUMMARY OF THE INVENTION

It has not been unexpectedly and surprisingly discovered that aqueous compositions containing organosilicon compounds and only small amount of volatile organic compounds can be used to modify inorganic, organic, or organosilicon substrates to improve their adhesion and stabilization as the compositions are storage stable, wet many substrates very well, and cure rapidly to form a transparent film.

### DESCRIPTION OF THE PREFERRED EMBODIMENTS

The invention relates to a composition produced by using

(A) 90 parts by weight of water,

(B) 0.1 to 10 parts by weight of amino functional silanes and/or partial hydrolyzates thereof and

(C) 0.005 to 0.5 parts by weight of carboxylic acids of the formula

R—(OCH₂CH₂)_{y}—OCH₂C(═O)OH (I),

wherein

R represents a hydrocarbon radical having 10 to 17 carbon atoms that is bonded via carbon and

y is an integer from 1 to 20

with the proviso that the weight ratio of (B)/(C) is in the range from 10 to 1000.

Examples of water (A) are natural waters such as rainwater, groundwater, spring water, river water, and sea water; chemical waters such as partially demineralized water, demineralized water, distilled or (multiply) redistilled water; waters for medical or pharmaceutical purposes such as purified water (Aqua purificata; Pharm. Eur. 3), Aqua deionisata, Aqua destillata, Aqua bidestillata, Aqua ad injectionam or Aqua conservata; drinking water according to German drinking water regulations, and mineral waters.

Preferably, water (A) is partially demineralized water, demineralized water, distilled or (multiply) redistilled water, and water for medical or pharmaceutical purposes, more preferably partially demineralized water and demineralized water.

Preferably, the water has a conductivity of preferably less than 50 μS/cm at 25° C. and 1010 hPa. Preferably, the water is air saturated, clear, and colorless.

Preferably, the silanes (B) are those of the formula

D_{b}Si(OR²)ₐR¹_{(4-a-b)/2} (II),

where

R¹ represents identical or different monovalent, substituted or unsubstituted, SiC-bonded, organic radical free from basic nitrogen,

R² represents identical or different hydrogen atom or substituted or unsubstituted hydrocarbon radicals which can be interrupted by one or more oxygen atoms,

D represents identical or different monovalent, SiC-bonded radical containing at least one group —NHR³, where R³ is identical to a hydrogen atom or substituted or unsubstituted hydrocarbon radicals,

a is 1, 2, or 3, preferably 2 or 3, more preferably 3 and

b is 1, 2, or 3, preferably 1,

with the proviso that the sum of a+b is equal to 3 or 4

and/or partial hydrolyzates thereof.

Examples of radicals R¹ are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical, isooctyl radicals, and the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radical, and methylcyclohexyl radicals; alkenyl radicals such as the vinyl, 1-propenyl, and the 2-propenyl radical; aryl radicals such as the phenyl, naphthyl, anthryl, and phenanthryl radical; alkaryl radicals such as o-, m-, p-tolyl radicals; xylyl radicals and ethylphenyl radicals; and aralkyl radicals such as the benzyl radical, the α- and the β-phenylethyl radical.

The radical R¹ is preferably a hydrocarbon radical having 1 to 18 carbon atoms, more preferably a hydrocarbon radical having 1 to 5 carbon atoms, especially the methyl radical.

Examples of substituted or unsubstituted hydrocarbon radicals R² are the examples cited for the radical R¹.

The radicals R² are preferably a hydrogen atom and hydrocarbon radicals having 1 to 18 carbon atoms which can be interrupted by one or more oxygen atoms, more preferably a hydrogen atom and hydrocarbon radicals having 1 to 10 carbon atoms, in particular the methyl radical and the ethyl radical.

Examples of substituted or unsubstituted hydrocarbon radicals R³ are the examples cited for radical R¹, which can be substituted by NH₂ groups or interrupted by NH groups.

The radicals R³ are preferably a hydrogen atom and hydrocarbon radicals having 1 to 18 carbon atoms which can be substituted by NH₂ groups or can be interrupted by NH groups. More preferably, the radical R³ is a hydrogen atom, n-butyl, 2-aminoethyl, N-(2-aminoethyl)-2-aminoethyl, and cyclohexyl radical.

Examples of radicals D are radicals of the formulae H₂N(CH₂)₃—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, C₃H₇NH(CH₂)₃—, C₄H₉NH(CH₂)₃—, C₅H₁₁NH(CH₂)₃—, C₆H₁₃NH(CH₂)₃—, C₇H₁₅NH(CH₂)₃—, H₂N (CH₂)₄—, H₂N—CH₂—CH(CH₃)—CH₂—, H₂N(CH₂))₅—, cyclo-C₅H₉NH(CH₂)₃—, cyclo-C₆H₁₁NH(CH₂)₃—, Phenyl-NH(CH₂)₃—, H₂NCH₂—, H₂N(CH₂)_{2—}NHCH₂—, H₂N(CH₂)₂NH(CH₂)₂NHCH₂—, H₃CNHCH₂—, C₂H₅NHCH₂—, C₃H₇NHCH₂—, C₄H₉NHCH₂—, C₅H₁₁NHCH₂—, C₆H₁₃NHCH₂—, C₇H₁₅NHCH₂—, cyclo-C₅H₉NHCH₂—, cyclo-C₆H₁₁NHCH₂—, phenyl-NHCH₂—, (CH₃O)₃Si(CH₂)₃NH(CH₂)₃—, (C₂H₅O)₃Si(CH₂)₃NH(CH₂)₃—, (CH₃O)₂(CH₃)Si(CH₂)₃NH(CH₂)₃— and (C₂H₅O)₂(CH₃)Si(CH₂)₃NH(CH₂)₃—.

Preferably, radical D is a SiC-bonded hydrocarbon radical having at least one group —NHR³, more preferably the H₂N(CH₂)₃—, H₂N(CH₂)₂NH(CH₂)₃—, cyclo-C₆H₁₁NH(CH₂)₃—, n-C₄H₉NHCH₂—, and cyclo-C₆H₁₁NHCH₂-radical.

Examples of the silanes (B) are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OC₂H₅)₂CH₃, n-C₄H₉NHCH₂—Si(OCH₃)₃, n-C₄H₉NHCH₂-Si(OC₂H₅)₂CH₃, n-C₄H₉NHCH₂—Si(OCH₃)₂CH₃, n-C₄H₉NHCH₂-Si(OC₂H₅)₃, cyclo-C₆H₁₁NHCH₂—Si(OC₂H₅)₃, cyclo-C₆H₁₁NHCH₂—Si(OCH₃)₃, cyclo-C₆H₁₁NHCH₂—Si(OC₂H₅)₂CH₃, and cyclo-C₆H₁₁NHCH₂—Si(OCH₃)₂CH₃, and also partial hydrolyzates thereof.

Preferably, silane (B) is H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OC₂H₅)₂CH₃, H₂N(CH₂)₂NH(CH₂)₃—Si(OCH₃)₂CH₃, n-C₄H₉NHCH₂—Si(OCH₃)₃, n-C₄H₉NHCH₂—Si(OC₂H₅)₃, cyclo-C₆H₁₁NHCH₂—Si(OC₂H₅)₃ and cyclo-C₆H₁₁NHCH₂—Si(OCH₃)₃, more preferably H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OC₂H₅)₂CH₃, and H₂N(CH₂)₂NH(CH₂)₃—Si(OCH₃)₂CH₃.

The silanes used as component (B), as a result of the process, and depending on the handling thereof, can contain certain amounts of partial hydrolyzates e.g. if they come into contact with moisture during storage and packaging. Preferably, component (B) contains up to 10% by weight partial hydrolyzate.

The partial hydrolyzates optionally present in component (B) preferably contain 2 to 10, more preferably 2 to 5, silicon atoms.

The component (B) is a commercially available product or can be produced by methods familiar in organosilicon chemistry.

Examples of the radical R are saturated linear or branched hydrocarbons such as the decyl, undecyl, dodecyl, tridecyl, tetradecyl, pentadecyl, or hexadecyl radical; saturated cyclic hydrocarbons such as the cyclohexylbutyl radical; unsaturated cyclic hydrocarbons such as the octylphenol and nonylphenol radical; and also unsaturated linear or branched hydrocarbons such as the decenyl, undecenyl, dodecenyl, tridecenyl, tetradecenyl, or hexadecenyl radical.

Preferably, radical R is alkyl and alkenyl radicals having 10 to 17 carbon atoms, each of which can be linear, branched and cyclic, more preferably linear and branched alkyl radicals having 10 to 17 carbon atoms, in particular linear and branched alkyl radicals having 10 to 16 carbon atoms.

Preferably, y is an integer from 1 to 10.

The carboxylic acids (C) have a molecular weight Mn of preferably 250 to 1000 g/mol.

The number average molecular weight Mn was determined by size exclusion chromatography (SEC) against polystyrene standard, in THF, at 40° C., flow rate 1.2 ml/min and detection using RI (refractive index detector) on a column set Styragel HR3-HR4-HR5-HR5 from Waters Corp. USA using an injection volume of 100 μl.

The weight ratio of (B)/(C) in the compositions is in the range from preferably 20 to 100.

The carboxylic acids (C) are preferably glycolic acid ethoxylate lauryl ether, and C13 alcohol polyethylene glycol ether carboxylic acid, more preferably glycolic acid ethoxylate lauryl ether having Mn approximately 356 g/mol, glycolic acid ethoxylate lauryl ether having Mn approximately 457 g/mol, glycolic acid ethoxylate lauryl ether having Mn approximately 685 g/mol, and C13 alcohol polyethylene glycol ether carboxylic acid having Mn approximately 566 g/mol.

The carboxylic acids (C) are commercially available products or can be produced by methods familiar in organosilicon chemistry.

In addition to the components (A), (B), and (C), the compositions can also contain further components such as (D) inorganic salts, (E) organic solvents, (F) organosilicon compounds which are free from amino groups, (G) compounds of the formula

R′—(OCH₂CH₂)_{y′}—OH (III),

wherein

R′ represents a hydrocarbon radical having 10 to 17 carbon atoms that is bound via carbon and

y′ is an integer from 1 to 20,

(H) in-can preservatives, and additives (I).

Examples of optionally used inorganic salts (D) are NaCl, KCl, LiCl, MgCl₂, CaCl₂, NaF, and KF, wherein they are preferably NaCl and KCl, and more preferably NaCl.

If the compositions contain component (D), it is preferably 0.001 to 2 parts by weight, more preferably 0.01 to 1 part by weight, in each case based on 100 parts by weight of the component (C). Preferably, the compositions contain component (D).

Examples of optionally used organic solvents (E) are alcohols such as methanol, ethanol, isopropanol, n-propanol, glycol, 1,2-propanediol, 1,3-propanediol and glycerol; lactams such as N-methyl-2-pyrrolidone, N-octyl-2-pyrrolidone, and caprolactam; tertiary carboxamides such as dimethylformamide and dimethylacetamide; acetals such as ethylal and acetaldehyde diethylacetal; urea derivatives such as dimethylpropyleneurea; ketoxime such as acetone oxime or 2-butanone oxime; and sulfoxides such as dimethylsulfoxide, wherein it is preferably methanol and ethanol.

If, for preparing the compositions component (E) is used, it is preferably 0.1 to 100 parts by weight, more preferably 1 to 70 parts by weight, in each case based on 100 parts by weight of the component (B). For preparing the compositions, preferably no component (E) is used. However, the compositions can contain alcohols which are formed by hydrolysis of organyloxy groups of the components used, preferably compound R²OH, where R² has the abovementioned meaning, such as methanol and ethanol.

Examples of optionally used organosilicon compounds (F) which are free from amino groups are tetraethoxysilane, methyltrimethoxysilane, bis(triethoxysilyl)ethane, vinyltriacetoxysilane, methyltriacetoxysilane, ethyltriacetoxysilane, methyl tributanone oxime silane, methyl triacetone oxime silane, N-(trimethoxy-silylmethyl)-O-methyl carbamate and N-(trimethoxy-silylpropyl)-O-methyl carbamate, wherein it is preferably tetraethoxysilane, methyltrimethoxysilane, bis(triethoxysilyl)ethane, vinyltriacetoxysilane, methyltriacetoxysilane and ethyltriacetoxysilane, and more preferably tetraethoxysilane, vinyltriacetoxysilane, methyltriacetoxysilane, and ethyltriacetoxysilane.

If the compositions contain component (F), it is preferably 0.1 to 50 parts by weight, more preferably to 10 parts by weight, in each case based on 100 parts by weight of component (B). The compositions do not contain component (F).

Examples of optionally used component (G) are lauryl ethoxylates and branched C13 alcohol polyethylene glycol ethers, in both cases in each case having 1 to 10 ethoxy units, wherein preferably R′ is identical to R, and y′ is identical to y.

If the compositions contain component (G), it is preferably 0.1 to 20 parts by weight, more preferably 1 to 10 parts by weight, in each case based on 100 parts by weight of component (C). The compositions preferably do not contain component (G).

Examples of optionally used in-can preservatives (H) are the customary in-can preservatives for the basic range such as benzoates such as sodium benzoate; pyrithiones such as sodium pyrithione, 1,2-benzisothiazoli-3-one; triazines such as hexahydro-1,3,5-tris(2-hydroxyethyl)-s-triazine, hexamethylenebiguanidine, 2-benzyl-4-chlorophenol, 1,2,3-benzotriazole, benzyl alcohol mono(poly)hemiformal, o-phenylphenol, sodium 2-phenylphenolate, benzalkonium chloride, and N-(2-hydroxypropyl)aminomethanol, wherein it is preferably benzoates such as sodium benzoate; pyrithiones such as sodium pyrithione, 1,2-benzisothiazoli-3-one; and triazines such as hexahydro-1,3,5-tris(2-hydroxyethyl)-s-triazine.

If the compositions contain component (H), it is preferably 0.0001 to 0.1 parts by weight, more preferably 0.001 to 0.05 parts by weight, in each case based on 100 parts by weight of component (A). The amount of component (H) added is dependent on many circumstances such as the labeling thresholds, the quality of the water used, the charging conditions, the storage vessels, the storage time, the storage temperature, and the conditions of use. A person skilled in the art knows what in-can preservatives are added, and in which amounts.

Examples of optionally used additives (I) are coloring, fluorescent or phosphorescent substances such as water-soluble natural dyes or synthetic dyes.

If the compositions contain component (I), it is preferably 0.0001 to 1 part by weight, more preferably 0.001 to 0.1 part by weight, in each case based on 100 parts by weight of component (A). The compositions preferably do not contain component (I).

Preferably, the compositions are those which in addition to the components (A), (B) and (C) further contain one or more further components selected from (D) inorganic salts, (E) organic solvents, (F) organosilicon compounds which are free from amino groups, (G) compounds of the formula (III), (H) in-can preservatives, and additives (I).

Beyond components (A) to (I), the compositions preferably do not contain further components.

For preparing the masses, all components can be mixed with one another in any desired sequence. In the case of the individual components, they can be in each case one type of such a component or else a mixture of at least two different types of such components.

The invention further relates to a process for producing the compositions by mixing the individual components.

Preferably, in the process, the water is charged first. The other components can then be added with stirring. If desired, premixes can also be produced such as component (C) with one part of the water (A) and also optionally inorganic salts (D) and optionally component (G).

Preferably, the mixing is carried out at atmospheric pressure, that is about 900 to 1100 hPa. In addition, it is possible to mix every so often or continuously under reduced pressure such as at 30 to 500 hPa absolute pressure to remove volatile compounds. Preferably, the mixing is carried out at temperatures of 10 to 50° C., more preferably at room temperature. The process can be carried out continuously or discontinuously.

The compositions are preferably clear and colorless. The compositions have a pH of preferably 8 to 11, more preferably 9 to 11. The compositions have a viscosity of preferably 0.5 to 5 mm²/s, more preferably 0.6 to 2.0 mm²/s, in each case measured at 25° C. The compositions are low in VOCs, meaning they have a content of volatile organic compounds having a boiling point below 200° C. at 1013 hPa of less than 10 percent by weight, based on the total mixture. The compositions can be used anywhere, where substrates are to be modified, e.g. for imparting adhesion, stabilization, and functionalization.

Examples of substrates are inorganic, organic, or organosilicon materials, preferably of any desired shape and surface.

Examples of inorganic materials are metal such as steel and aluminum, glass, minerals, entities made of glass fibers and carbon fibers, and also siliceous building materials such as concrete, stoneware, porcelain, and gypsum.

Examples of organic materials are wood, paper, plastics such as polyester, polycarbonate, polyvinyl chloride, polyvinylidene difluoride, polyamide, polyacrylonitrile, polyethylene, polypropylene, and polyurethane, as molded parts, films, or fibrous materials, natural fibrous materials such as wool, cotton, silk, flax, and fibers made of regenerated cellulose, and also flat textile entities made of artificial and/or natural fibrous materials such as, woven fabric, loop-jointly knitted fabrics, loop-forming knitted fabrics, bonded fabrics, braded fabrics, stitch-bonded fabrics and fleece fabrics such as the material Tyvek® from DuPont.

Examples of organosilicon materials are silicone rubbers.

The invention further relates to a process for modifying substrates in which the composition is applied to the substrate.

In the process, the surfaces of the substrates are preferably dry and clean and also free from loose subsoils, dust, dirt, rust, oil, and similar impurities. Before the treatment, the surfaces can be dried, cleaned, and/or modified by any desired processes which are known, for instance cleaned by using organic solvents, alkaline or acidic solutions, treatment with hot gases, flames, plasma, corona, laser beams, ultrasound, ceramic blasting abrasives, or CO₂ snow blasting, or by cutting or non-cutting processes such as grinding, lapping, polishing, or brushing.

In the process, the application can proceed by suitable and known methods such as immersion, painting, rolling, brushing, wiping, application with a roller, or spraying.

Preferably, the application is carried out at atmospheric pressure, that is about 900 to 1100 hPa. Preferably, the application is carried out at temperatures of 5 to 50° C., more preferably at room temperature. The process for modifying substrates can be carried out continuously or discontinuously. The composition cures even at room temperature and at atmospheric pressure within a short time after vaporization or evaporation of the solvent fraction, water, and optionally organic solvent. As is known, the drying time is dependent on temperature, absolute pressure, atmospheric humidity, air velocity, layer thickness, and material properties, in particular absorbency.

Preferably, a transparent, solid application is obtained. If it is desirable to receive a detectable application, coloring, fluorescent, or phosphorescent substances can be added.

The present invention further relates to molded bodies produced by crosslinking the compositions.

The modified substrate is especially suitable for the application of paints, coatings, adhesives, and sealing compounds.

The compositions have the advantage that they may be readily produced and are storage stable. The compositions have the advantage that they contain only small amounts of volatile organic compounds. In addition, the compositions have the advantage that they wet many substrates very well and cure rapidly to form a transparent film. The process for modifying substrates has the advantage that it can be carried out simply, is employable on large surfaces, and is suitable for differing materials.

In the examples described hereinafter, all viscosity data relate to a temperature of 25° C. Where not stated otherwise, the examples hereinafter are carried out at atmospheric pressure, that is about 1000 hPa, and at room temperature, that about 23° C., or at a temperature which is established on combining the reactants at room temperature without additional heating or cooling, and also at a relative humidity of about 50%. In addition, all data of parts and percentages, where not stated otherwise, relate to the weight.

For determining the pH, the freshly produced composition is allowed to stand for one hour and then a small sample is applied to universal indicator paper (e.g. universal indicator from Merck, Germany, with a measurement range of pH 1-14). The pH is determined after 1 to 3 min of action by comparison with the color scale.

### Test 1

### Determination of the Drying Time

To determine the drying time, the compositions obtained in the examples are applied to a glass plate using a brush and are stored at 25° C. and 50% relative humidity. During the curing, the formation of a dry layer is tested every 5 min. For this purpose, a dry and fat-free finger is carefully positioned on the coated surface and drawn upwards. If sample remains adhering to the finger or if the finger leaves behind an imprint on the surface, the composition is not yet dry. If the finger does not leave an impression behind, the surface is dried and the time is recorded. If the sample is indeed dry, but on testing can easily be wiped off, the test has not been passed, and receives the note “wipeable off.”

### Test 2

### Determination of the Spreading Behavior

To determine the spreading behavior, the compositions obtained in the examples are applied by a brush to a glass plate, eloxed aluminum and cast PMMA and stored at 25° C. and 50% relative humidity. After 30 minutes, the spreading behavior is assessed visually; if the coated region is completely wetted, the spreading behavior is in order (+), otherwise not (−).

### Test 3

### Assessment of Adhesion

The substrates under test are coated with the compositions produced in the examples and stored for 30 minutes at 25° C. and 50% relative humidity. To determine the adhesion, masses that are crosslinkable at room temperature by ingress of water (commercially available under the name GENIOSIL® N35C from Wacker Chemie AG) are applied to the substrates under test in a 2 mm thick layer and stored for seven days at 25° C. and 50% relative humidity and then the adhesion is tested. Then, the test body is completely covered with water and stored for seven days at 25° C. and thereafter the adhesion is tested. To test the adhesion, an approximately 1 cm long piece of the vulcanized rubber is scraped off from the substrate and drawn thereon in the direction of the still-adhering rubber until failure. If the rubber itself tears, the adhesion is in order and is rated “1.” If the rubber may be partially torn off from the substrate, the adhesion is rated “3.”

If the rubber may be pulled off from the substrate without residue, the adhesion is poor and is rated “5.”

The following components are used:
Surfactant T1: Glycolic acid ethoxylate lauryl ether (Mn=360 g/mol) (commercially available under the name AKYPO RLM 25 at KAO Chemicals GmbH, D-Emmerich), 93% pure, contains 6.8% water and 0.2% NaCl;
Surfactant T2: Glycolic acid ethoxylate lauryl ether (Mn=460 g/mol) (commercially available under the name AKYPO RLM 45 at KAO Chemicals GmbH, D-Emmerich), 92% pure, contains 7.5% water and 0.5% NaCl;
Surfactant T3: Glycolic acid ethoxylate lauryl ether (Mn=700 g/mol) (commercially available under the name AKYPO RLM 100 at KAO Chemicals GmbH, D-Emmerich), 88% pure, contains 11% water and 1% NaCl;
Surfactant T4: Glycolic acid ethoxylate octyl ether (Mn=410 g/mol) (commercially available under the name AKYPO LF1 at KAO Chemicals GmbH, D-Emmerich), 90% pure, contains 9.5% water and 0.5% NaCl;
Surfactant T5: Glycolic acid ethoxylate octyl ether (Mn=550 g/mol) (commercially available under the name AKYPO LF2 at KAO Chemicals GmbH, D-Emmerich), 89% pure, contains 10% water and 1% NaCl;
Surfactant T6: Glycolic acid ethoxylate oleyl ether (Mn=410 g/mol) (commercially available under the name AKYPO RO 20 VG at KAO Chemicals GmbH, D-Emmerich), 95% pure, contains 4.5% water and 0.5% NaCl;
Surfactant T7: Glycolic acid ethoxylate oleyl ether (Mn=540 g/mol) (commercially available under the name AKYPO RO 50 VG at KAO Chemicals GmbH, D-Emmerich), 92% pure, contains 7.5% water and 0.5% NaCl;
Surfactant T8: C10-Guerbert alcohol having 5 ethoxy groups (commercially available under the name Lutensol XL 50 at BASF SE, D-Ludwigshafen);
Surfactant T9: C10-Guerbert alcohol having 9 ethoxy groups (commercially available under the name Lutensol XL 90 at BASF SE, D-Ludwigshafen);
Surfactant T10: C13 alcohol having 5 ethoxy groups (commercially available under the name Lutensol TO 5 at BASF SE, D-Ludwigshafen);
Surfactant T11: C13 alcohol having 6 ethoxy groups (commercially available under the name Lutensol TO 6 at BASF SE, D-Ludwigshafen);
Surfactant T12: C13 alcohol having 8 ethoxy groups (commercially available under the name Lutensol TO 8 at BASF SE, D-Ludwigshafen);
Surfactant T13: C13 alcohol polyethylene glycol ether carboxylic acid (Mn=570 g/mol) (commercially available under the name MARLOWET 4538 at SASOL Germany GmbH, D-Marl), 70% pure, contains 19% ethoxylated isotridecanol (Mn=510), 10% water and 1% NaCl;
Surfactant T14: neodecanoic acid (commercially available at Sigma-Aldrich Chemie GmbH, D-Taufkirchen);
Surfactant T15: n-octanoic acid (commercially available under the name caprylic acid at Sigma-Aldrich Chemie GmbH, D-Taufkirchen);
Silane S1: (3-aminopropyl)trimethoxysilane (commercially available under the name GENIOSIL® GF 96 at Wacker Chemie AG, D-Munich);
Silane S2: (3-aminopropyl)triethoxysilane (commercially available under the name GENIOSIL® GF 93 at Wacker Chemie AG, D-Munich);
Silane S3: N-(2-aminoethyl)(3-aminopropyl)trimethoxy-silane (commercially available under the name GENIOSIL® GF 91 at Wacker Chemie AG, D-Munich);
Silane S4: (3-glycidoxypropyl)trimethoxysilane (commercially available under the name GENIOSIL® GF 80 at Wacker Chemie AG, D-Munich) and
Silane S5: (N-morpholinomethyl)triethoxysilane.

### EXAMPLE 1 (B1)

### Production of Composition 1

90 g of demineralized water having a conductivity of 25 μS/cm, 2.7 g of 3-aminopropyl-trimethoxysilane (silane S1) and 0.1 g of glycolic acid ethoxylate lauryl ether (surfactant 1) were mixed in a glass flask and closed. A clear colorless liquid having a pH of 10 was obtained. After storage for one day at room temperature, tests 1 and 2 are carried out. The results are in table 1.

### EXAMPLES 2 TO 9 (B2-B9)

The procedure described in example 1 was repeated with the modification that type and amount of silane and surfactant were varied as cited in table 1.After storage for one day at room temperature, in each case, tests 1 and 2 are carried out. The results are in table 1.

### Comparative Examples 1 to 14 (C1-C14)

The procedure described in example 1 was repeated with the modification that type and amount of silane and surfactant were varied as cited in table 1. After storage for one day at room temperature, in each case, tests 1 and 2 are carried out. The results are in table 1.

### Comparative Example 15 (C15)

The procedure described in example 1 is repeated with the modification that no surfactant is added. The results are in table 1.

TABLE 1

| | | | | | Drying | | |
|---|---|---|---|---|---|---|---|
| | | Silane | | Surfactant | time | Spreading | Spreading |
| Example | Silane | amount [g] | Surfactant | amount [g] | [min] | on glass | on Alu |
| B1 | S1 | 2.7 | T1 | 0.1 | 10 | + | + |
| B2 | S1 | 3.6 | T1 | 0.05 | 10 | + | + |
| B3 | S1 | 1.0 | T1 | 0.15 | 5 | + | + |
| B4 | S1 | 7.2 | T1 | 0.15 | 10 | + | + |
| B5 | S1 | 2.7 | T2 | 0.1 | 10 | + | + |
| B6 | S1 | 2.7 | T13 | 0.1 | 10 | + | + |
| B7 | S1 | 2.7 | T3 | 0.1 | 10 | + | + |
| B8 | S3 | 2.7 | T1 | 0.1 | 30 | + | + |
| B9 | S2 | 2.7 | T2 | 0.1 | 10 | + | + |
| C1 | S1 | 2.7 | T10 | 0.1 | cloudy | − | − |
| C2 | S1 | 2.7 | T11 | 0.1 | cloudy | − | − |
| C3 | S1 | 2.7 | T12 | 0.1 | wipeable | + | + |
| | | | | | off | | |
| C4 | S1 | 2.7 | T8 | 0.1 | wipeable | + | + |
| | | | | | off | | |
| C5 | S1 | 2.7 | T9 | 0.1 | wipeable | + | + |
| | | | | | off | | |
| C6 | S1 | 2.7 | T15 | 0.1 | n.d. | − | − |
| C7 | S1 | 2.7 | T14 | 0.1 | n.d. | − | − |
| C8 | S1 | 2.7 | T4 | 0.1 | n.d. | − | − |
| C9 | S1 | 2.7 | T5 | 0.1 | n.d. | − | − |
| C10 | S1 | 2.7 | T6 | 0.1 | n.d. | − | − |
| C11 | S1 | 2.7 | T7 | 0.1 | n.d. | − | − |
| C15 | S1 | 2.7 | none | − | n.d. | − | − |
| C12 | S1 | 2.7 | T1 | 1.0 | n.d. | − | − |
| C13 | S4 | 2.7 | T1 | 0.1 | 20 | − | − |
| C14 | S5 | 2.7 | T1 | 0.1 | wipeable | + | + |
| | | | | | off | | |

n.d. = not determinable

### EXAMPLE 10 (B10)

### Adhesion of Composition 1

To assess the adhesion, test bodies made of eloxed aluminum, hard PVC, and ABS were pretreated with composition 1. The results are in table 2.

### Comparative Example 16 (C16)

The procedure described in example 10 is repeated with the modification that the test bodies were not pretreated. The results are in table 2.

### Comparative Example 17 (C17)

The procedure described in example 10 is repeated with the modification that the test bodies were pretreated with the composition of C4 (contains surfactant T8). The results are in table 2.

TABLE 2

| | | | | | Adhesion on | Adhesion on | Adhesion on ABS |
|---|---|---|---|---|---|---|---|
| | | Silane | | Surfactant | Alu (7 d RT/7 d | PVC (7 d RT/7 d | (7 d RT/7 d RT + 7 d |
| Example | Silane | amount [g] | Surfactant | amount [g] | RT + 7 d water) | RT + 7 d water) | water) |
| B1O | S1 | 2.7 | T1 | 0.1 | 1/1 | 1/5 | 1/1 |
| C16 | S1 | 2.7 | none | − | 1/5 | 5/5 | 5/5 |
| C17 | S1 | 2.7 | T8 | 0.1 | 1/5 | 5/5 | 1/5 |

1.-10. (canceled)

11. A composition comprising:
(A) 90 parts by weight of water,
(B) 0.1 to 10 parts by weight of amino functional silanes and/or partial hydrolyzates thereof, and
(C) 0.005 to 0.5 parts by weight of carboxylic acids of the formula
R—(OCH₂CH₂)_{y}—OCH₂C(═O)OH (I),
where
R represents a hydrocarbon radical having 10 to 17 carbon atoms that is bonded via carbon and
y is an integer from 1 to 20
with the proviso that the weight ratio of (B)/(C) is in the range from 10 to 1000.

12. The composition of claim 11, wherein (B) are silanes of the formula
D_{b}Si(OR²)ₐR¹_{(4-a-b)/2} (II),
where
R¹ is an identical or different monovalent, substituted or unsubstituted, SiC-bonded, organic radical free from basic nitrogen,
R² is identical or different hydrogen atom or substituted or unsubstituted hydrocarbon radicals, optionally interrupted by one or more oxygen atoms,
D is an identical or different monovalent, SiC-bonded radical containing at least one group —NHR³, where R³ is hydrogen or a substituted or unsubstituted hydrocarbon radical,
a is 1, 2, or 3,
b is 1, 2 or 3,
with the proviso that the sum of a+b is equal to 3 or 4,
and/or
partial hydrolyzates thereof.

13. The composition of claim 12, wherein a is 2 or 3 and b is 1.

14. The composition of claim 11, wherein the carboxylic acids (C) comprise glycolic acid ethoxylate lauryl ether, glycolic acid ethoxylate lauryl ether, glycolic acid ethoxylate lauryl ether, or C13 alcohol polyethylene glycol ether carboxylic acid.

15. The composition of claim 11 further comprising one or more components selected from the group consisting of (D) inorganic salts, (E) organic solvents, (F) organosilicon compounds which are free from amino groups, (G) compounds of the formula (III), (H) pot preservatives, additives (I), and mixtures thereof.

16. The composition of claim 15, wherein the formula (III) is
R′—(OCH₂CH₂)_{y′}—OH (III),
wherein
R′ represents a hydrocarbon radical having 10 to 17 carbon atoms bonded via carbon and
y′ is an integer from 1 to 20.

17. The composition of claim 15, wherein the composition is free from components other than the components (A) to (I).

18. The composition of claim 11, wherein the composition has pH of 8 to 11.

19. A process for producing the composition of claim 11 by mixing the individual components.

20. A process for modifying substrates, in which the composition of claim 11 is applied to a substrate.

21. A process for modifying substrates, in which the composition as produced in claim 19 is applied to a substrate.

22. The process of claim 20, wherein the substrate comprises an inorganic, organic, or organosilicon material.

23. The process of claim 21, wherein the substrate comprises an inorganic, organic, or organosilicon material.

24. A molded body produced by crosslinking two or more compositions of claim 11.

25. A molded body produced by crosslinking two or more compositions as produced in claim 19.
